(19) United States
(12) Patent Application Publication
(10) Pub. No.: US 2017/0266620 A1
(43) Pub. Date: Sep. 21, 2017

(54) PRESSURE PROCESSING SYSTEMS AND METHODS

(71) Applicant: Elwha LLC, Bellevue, WA (US)

(72) Inventors: Hon Wah Chin, Palo Alto, CA (US); Roderick A. Hyde, Redmond, WA (US); Jordin T. Kare, San Jose, CA (US); Lowell L. Wood, JR., Bellevue, WA (US)

(21) Appl. No.: 15/073,466

(22) Filed: Mar. 17, 2016

(51) Int. Cl. B01D 61/10; B01D 61/02

(52) U.S. Cl. CPC B01D 61/10; B01D 61/025; B01D 2313/90

(57) ABSTRACT

Pressure processing systems disclosed herein comprise rotating fluid flow paths. Transfer of angular momentum between the working fluid and the fluid flow path may be configured to increase pressure within the system and/or recover energy used to increase pressure within the system. Rotation of pressure processing systems may be configured to alter working fluid pressure within the pressure processing system. Filtration and/or chemical processes may be performed within a pressure processing portion of such systems. Working fluid may be introduced or recovered from the system at various radial positions.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 U.S.C. §119(e) for provisional patent applications, for any and all parent, grandparent, great-grandparent, etc. applications of the Priority Application(s)). In addition, the present application is related to the “Related Applications,” if any, listed below.

### Priority Applications

None

### Related Applications

If the listings of applications provided herein are inconsistent with the listings provided via an ADS, it is the intent of the Applicants to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### TECHNICAL FIELD

The present disclosure relates generally to pressure processing systems, including systems configured to processes fluids while at an elevated pressure. The present disclosure further relates to systems which increase or otherwise alter the pressure within a fluid flow path through rotation of all or a portion of the fluid flow path.

### BRIEF DESCRIPTION OF THE DRAWINGS

The embodiments disclosed herein will become more fully apparent from the following description and appended claims, taken in conjunction with the accompanying drawings. The drawings depict exemplary embodiments of the present disclosure. Various features of these embodiments will be described with additional specificity and detail through reference to the drawings, in which:

FIG. 1 is a schematic illustration of a side view of an embodiment of a flow path of a pressure processing system.

FIG. 2 is a schematic illustration of a top view of an embodiment of a pressure processing system comprising multiple flow paths.

FIG. 3 is a schematic illustration of a side view of another embodiment of a flow path of a pressure processing system.

FIG. 4 is a schematic illustration of side view of yet another embodiment of a flow path of a pressure processing system.

FIG. 5 is a schematic illustration of a cross-sectional view of another embodiment of a pressure processing system.

FIG. 6 is a schematic illustration of a cross-sectional view of another embodiment of a flow path of a pressure processing system.

### DETAILED DESCRIPTION

Systems may be configured for pressure processing of fluids using rotating pressure paths. Fluid disposed radially outward from an axis of rotation may thus have a higher pressure relative to fluid disposed nearer the axis of rotation. Displacement of fluid away from an axis of rotation may thus increase the pressure, while displacement of the fluid back toward the axis of rotation may decrease the pressure and recover the work, or a portion of the work, initially expended to increase the fluid pressure.

Fluid systems which may process fluids at elevated pressures include filtration processes, including water filtration and reverse osmosis, chemical reactions, and so forth.

It will be readily understood that the components of the embodiments as generally described and illustrated in the Figures herein could be arranged and designed in a wide variety of different configurations. Thus, the following more detailed description of various embodiments, as represented in the Figures, is not intended to limit the scope of the disclosure, but is merely representative of various embodiments. While the various aspects of the embodiments are presented in drawings, the drawings are not necessarily drawn to scale unless specifically indicated.

The phrases “connected to,” “coupled to,” and “in communication with” refer to any form of interaction between two or more entities, including mechanical, electrical, magnetic, electromagnetic, fluid, and thermal interaction. Two components may be coupled to each other even though they are not in direct contact with each other. For example, two components may be coupled to each other through an intermediate component.

As used herein the term “centrifugal force” refers to an apparent force acting to move a body away from the axis of rotation when the body is rotated about that axis, as viewed from a non-rotating reference frame. This apparent force may be understood as due to inertia of the body as it is accelerated or as a reaction force to a centripetal force which acts on the body toward the axis of rotation.

As used herein, steady-state operation of a system refers to an operational state wherein energy is only input into the system to overcome losses or maintain operation. For example, some systems may use more energy while initially starting the system, for example while initially accelerating a body to a constant velocity. Steady-state operation would thus entail maintaining that body at the constant velocity, only inputting energy to overcome losses such as drag.

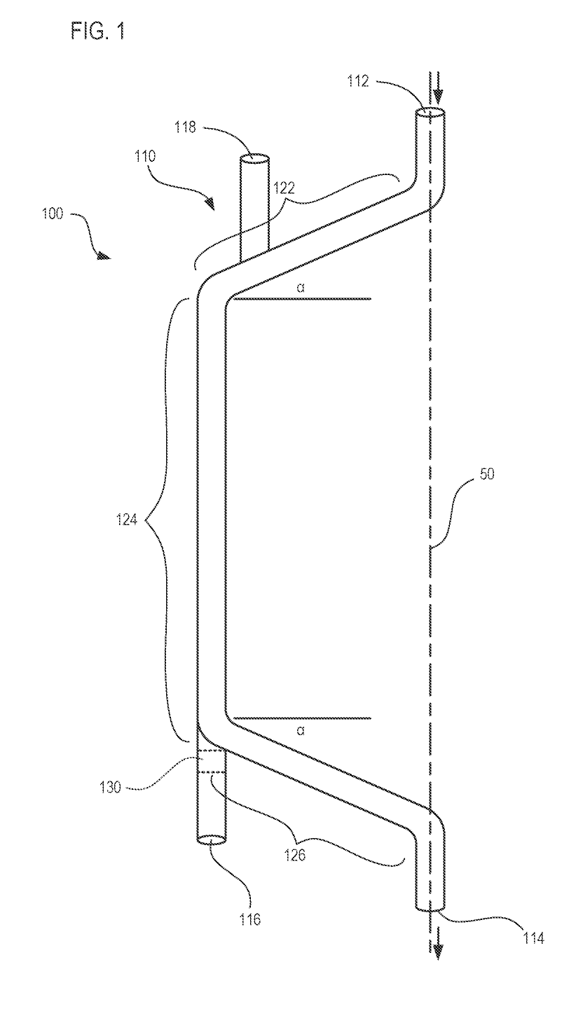

FIG. 1 is a schematic illustration of a side view of an embodiment of a fluid flow path 110 of a pressure processing system 100. The fluid flow path 110 includes a flow path inlet 112 and a flow path outlet 114. Additionally, an axis of rotation 50 is shown in the illustrated embodiment.

A working fluid with the fluid flow path 110 may be subject to a pressure differential due to rotation of the fluid flow path 110 about the axis of rotation 50. In other words, centrifugal force acting on working fluid within a first segment, the pressure developing portion 122, and a second segment, the pressure recovery portion 126, of the fluid flow path 110 may result in increased pressure in a third segment, the pressure processing portion 124 of the fluid flow path 110.

Working fluid may be displaced or flow through the working fluid flow path 110 during operation of the system 100. In other words, the system 100 may be configured as a continuous processing system. Angular momentum may be transferred to working fluid flowing through the pressure developing portion 122 during operation of the system 100. Further, as working fluid leaves the pressure processing portion 124 and flows through the pressure recovery portion 126, angular momentum may be transferred from the working fluid to the fluid flow path 110. Thus, work used to initially accelerate a given portion of the working fluid may be at least partially recovered and used to accelerate additional fluid entering the system 100 while in steady-state operation.

In this way, working fluid pressure at the pressure inlet 112 and pressure outlet 114 may be near ambient pressure while pressure within the pressure processing portion 124 is much higher. The system 100 can thus facilitate recovery of work done on the working fluid to accelerate and compress the working fluid. This recovered work, transferred back into the system 100 as angular momentum, is thus utilized to accelerate working fluid entering the system 100, thus facilitating maintenance of steady-state operation of the system 100.

As shown in FIG. 1, the working fluid can be accelerated simply by interaction between the working fluid and the walls of the fluid flow path 110 as the fluid flow path 110 rotates. For example, as the fluid flow path 110 is rotated about the axis of rotation 50, the inside walls of the fluid flow path 110 act on the working fluid. Recovery of the kinetic energy of the working fluid may be due to the same types of interactions, with the working fluid acting on the walls of the fluid flow path 110.

A drive system, such as a motor, may be configured to input angular momentum (i.e., apply torque) into the system 100. The drive system may be configured to provide the work needed to start the system 100 and bring it up to steady-state operation. Furthermore, the drive system may be configured to compensate for losses in the system 100 to maintain the system 100 at steady-state operation. In some embodiments, the drive system may also be configured to decelerate the system when the system is shut down. In some embodiments, the drive system may recover a portion of the energy stored in the rotating system during such a shutdown process.

Thus, in some embodiments, the angular momentum transferred to the working fluid by the fluid flow path 110 may be substantially equal to the angular momentum transferred from the working fluid back to the fluid flow path 110 when the system 100 is in steady-state operation. Due to potential losses in the system 100 (such as friction and/or drag) the angular momentum transferred to the working fluid may be less than the angular momentum transferred from the working fluid when the system 100 is in steady-state operation. Still further, the system 100 may be configured such that only a portion of the work input into the system 100 is recovered, due to factors other than losses (such as leakage or deliberate extraction of a portion of the fluid mass from the high-pressure section).

The pressure of the working fluid within the pressure processing portion 124 will be correlated with the rotational velocity of the fluid flow path 110. The higher the rotational velocity, the greater the working fluid pressure in the pressure processing portion 124. For a fixed geometry and fluid density, the working fluid pressure will be proportional to the square of the rotational velocity.

Notwithstanding high pressure in the pressure processing portion 124, working fluid pressure at the pressure inlet 112 and pressure outlet 114 may be at or near ambient pressure. To facilitate working fluid flow through the fluid flow path 110, working fluid pressure at the inlet 112 may be higher than working fluid pressure at the outlet 114. In some embodiments, for example, working fluid may be pumped to the working fluid flow path. Further, in some instances continuous working fluid flow through the fluid path 110 may be produced by a pressure differential (head) between the fluid inlet 112 and the Ifuid outlet 114. In some embodiments, this head may be provided by some combination of positive fluid pressure (e.g. from a pump or a gravity head) applied to the inlet and negative fluid pressure (suction) applied to the outlet. In other embodiments, the head may be provided at least in part by locating the outlet farther from the axis of rotation than the inlet, thus creating, in the rotating frame, a drop in potential energy (“height”) between the inlet and outlet. In yet other embodiments. the fluid density may be changed (decreased) between the inlet and outlet (e.g., by the separation and removal of a dense component such as a suspended solid, or by the formation of a gaseous component from a liquid) such that the pressure increase from the inlet to the maximum radius of the flow path is greater than the presssure decrease from the maximum radius to the outlet.

Rotating seals may be used at the inlet 112 and outlet 114 to control flow at these locations from secondary apparatuses such as fluid delivery lines, pumps, and so forth. As fluid pressure may be near ambient at the inlet 112 and outlet 114, any such seals may be configured for use with pressures much smaller than the fluid pressure in the pressure processing portion 124. Further, depending on the design of fluid delivery and recovery systems, seals at the inlet 112 and outlet 114 may not be needed.

In some embodiments, gravity may be utilized the induce flow through the fluid flow path 110 from the inlet 112 to the outlet 114. For example, the fluid flow path 110 may be oriented such that the inlet 112 is located above the outlet 114, with respect to gravity. For example, in the embodiment of FIG. 1, the axis of rotation 50 may be parallel to the direction of the force of gravity.

In some embodiments, the pressure developing portion 122 and/or pressure recovery portion 126 may be angled with respect to the pressure processing portion 124 and the axis of rotation 50. In the illustrated embodiment, these angles are shown as angles α. In other embodiments, only one of the pressure developing portion 122 and pressure recovery portion 126 may be angled, or each could form a different angle with respect to the pressure processing portion 124 and the axis of rotation 50. In the illustrated embodiment, when the axis of rotation 50 is parallel with the direction of gravity, these angled portions facilitate flow through the fluid flow path 110.

The fluid flow path 110 may comprise a generally U-shaped flow path, though the pressure developing 122 and pressure recovery 126 portions extending from the base of the U-shape may be angled in some instances. The pressure processing portion 124 may or may not be parallel to the axis of rotation 50, and one or more portions of the fluid flow path 110 may comprise curved segments.

The fluid flow path 110 may comprise a tube, pipe, or other enclosed passage for the working fluid. The fluid flow path 110 may comprise rigid walls to contain working fluid pressure and to interact with the working fluid to transfer momentum to and from the working fluid with minimal losses.

Fluid flow paths 110 having uniform cross-sections or fluid flow paths 110 with different cross-sections in different segments, areas, or portions are within the scope of this disclosure. The fluid flow path 110 may comprise one, two, three, four, or any number of cross-sectional profiles along any length or portion thereof.

The fluid flow path 110 may be formed of a tube or other structure comprising a single material, or may be comprised of two, three, four, or more materials. For instance, in some embodiments, the pressure processing portion 124 may comprise a different material than the pressure developing portion 122 and/or the pressure recovery portion 126. In some embodiments, portions of the fluid flow path 110 closer to the axis of rotation may be configured for use with lower working fluid pressures than portions of the fluid flow path 110 closer to the pressure processing portion 124.

In the embodiment of FIG. 1, both the inlet 112 and the outlet 114 are disposed at same radial distance from the axis of rotation 50. Specifically, in the illustrated embodiment, both the inlet 112 and the outlet 114 are disposed along the axis of rotation 50. In other embodiments, one or both the inlet 112 and the outlet 114 may be radially displaced from the axis of rotation 50.

The relative positions of the inlet 112 and the outlet 114 may induce a pressure gradient, and therefore working fluid flow, across the fluid flow path 110. For example, in embodiments wherein the inlet 112 is disposed radially inward with respect to the outlet 114, working fluid pressure within the system 100 will promote working fluid flow through the fluid flow path 110. For instance, if the inlet 112 is disposed at the axis of rotation 50 and the outlet 114 is disposed radially outward from the axis of rotation 50, working fluid pressure at the inlet 112 may be near ambient, while working fluid pressure at the outlet 114 may exceed ambient, resulting in expulsion of working fluid from the fluid flow path 110 at the outlet 114.

In some embodiments, the system 100 may further comprise an auxiliary outlet 116. For instance, in some applications a portion of the working fluid may be removed from the system 100 at a point other than the outlet 114. In one example, the system 100 may be configured as a filtration system 100. Portions of the working fluid may be forced through a filter 130 at high pressure, while the remaining working fluid may continue to the outlet 114. Filtered working fluid could thus be collected at the auxiliary outlet 116.

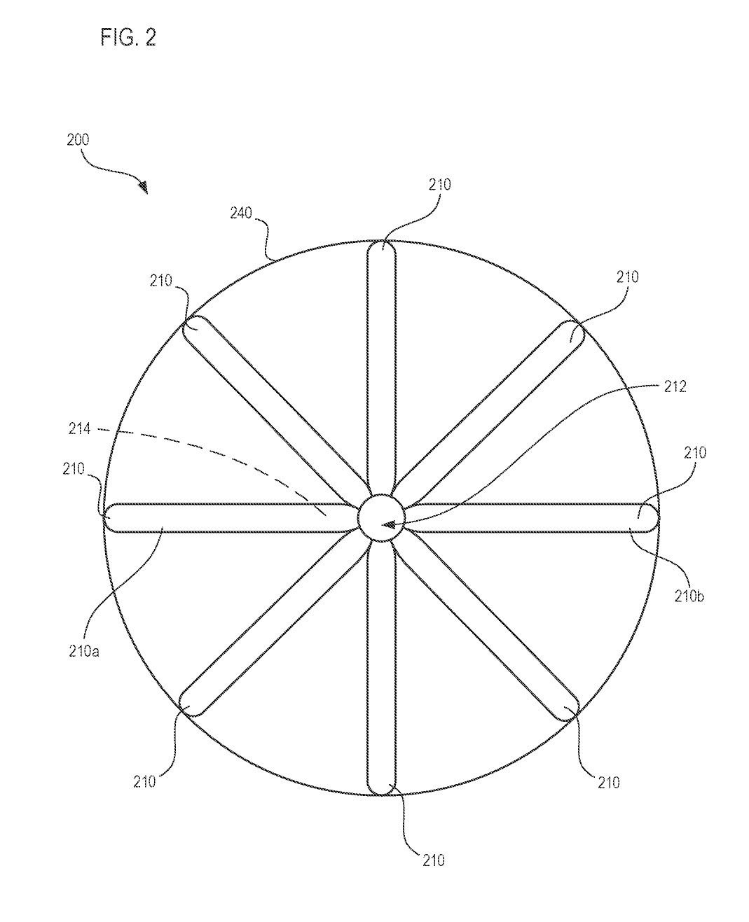

One such application is water filtration. The filter 130 may comprise a semipermeable membrane for reverse osmosis water filtration. The filter 130 is schematically illustrated in the embodiment of FIG. 2; such a membrane may extend along a portion of the pressure processing portion 124, for instance. At high pressure, unfiltered water in contact with the semipermeable membrane may result in water molecules migrating across the membrane, while some water, and contaminants, remain in the fluid flow path 110. The filtered water would be expelled from the auxiliary outlet 116 while unfiltered water would flow to the outlet 114.

Other potential applications include processes wherein the working fluid undergoes a chemical or other reaction when at high pressures. In such embodiments, the working fluid may be fed into the inlet 112, processed in the pressure processing portion 124, and recovered from the outlet 114. No auxiliary outlet 116 may be needed in such embodiments.

Furthermore, systems comprising multiple auxiliary outputs 116 in differing radial positions are within the scope of this disclosure. Such systems may be configured to separate or isolate certain elements of the working fluid through filtration or other processing at differing pressures.

In some embodiments, two working fluids may be processed together at a high pressure. In such instances, it may be desirable to introduce the fluids at different radial positions of the system 100. Accordingly, the working fluids may be introduced to the system 100 at different pressures. In some instances, working fluids with different specific gravities or densities may be introduced at different radial positions (and therefore different pressures) to reduce stratification of the working fluids while processing.

In some instances the system 100 may also comprise an auxiliary inlet 118. Systems may have neither an auxiliary output 116 nor an auxiliary inlet 118, have both, or have only one of the two. In some embodiments, one or more inputs or outputs may be configured to terminate in concentric fittings around a primary on-axis inlet or outlet. Such a concentric input or output may emply any suitable concentric rotary fluid coupling, either with simple spatially-separated flows or with, e.g., sliding seals, serpentine seals, ferrofluid seals, etc.). In other embodiments additional inputs or outputs may be located away from the rotation axis and use either cylindrical fluid couplings or open “spigot and trough” configurations.

FIG. 2 is a schematic illustration of a top view of an embodiment of a pressure processing system 200 comprising multiple flow paths 210.

The embodiment of FIG. 2 may include components that resemble components of the embodiment of FIG. 1 in some respects. For example, the embodiment of FIG. 2 includes fluid flow paths 210 of the system 200 that may resemble the fluid flow path 110 of FIG. 1. It will be appreciated that all the illustrated embodiments have analogous features and components. Accordingly, like or analogous features are designated with like reference numerals, with the leading digits incremented to “2.” Relevant disclosure set forth above regarding similarly identified features thus may not be repeated hereafter. Moreover, specific features of the system and related components shown in FIG. 2 may not be shown or identified by a reference numeral in the drawings or specifically discussed in the written description that follows. However, such features may clearly be the same, or substantially the same, as features depicted in other embodiments and/or described with respect to such embodiments. Accordingly, the relevant descriptions of such features apply equally to the features of the system and related components of FIG. 2. Any suitable combination of the features, and variations of the same, described with respect to the system and components illustrated in FIG. 1 can be employed with the system and components of FIG. 2, and vice versa. This pattern of disclosure applies equally to further embodiments depicted in subsequent figures and described hereafter.

It will be appreciated by one of skill in the art having the benefit of this disclosure that the system 200 of FIG. 2 may function in an analogous manner to the system 100 described in connection with FIG. 1. Thus, while specific features and elements of the system 200 will be described below, disclosure above regarding the relationship of components and the function of the system 100 of FIG. 1 may be applied to the system 200 of FIG. 2. Again, this pattern of disclosure applies to subsequent disclosure as well: disclosure relative to any embodiment may be analogously applied to any other embodiment herein.

In some embodiments, pressure processing systems within the scope of this disclosure may have multiple flow paths. For example, in the embodiment of FIG. 2, the system 200 comprises eight flow paths 210. Systems with more or fewer flow paths are within the scope of this disclosure.

In some embodiments, each fluid flow path 210 may comprise a separate and discrete inlet or outlet. Each discrete inlet and/or outlet may also be in fluid communication with a system inlet 212 and a system outlet 214. The system inlet 212 and system outlet 214 may comprise a manifold or other structure configured to distribute working fluid throughout the system 200. In the illustrated embodiment, a single system inlet 212 and outlet 214 are designated by reference numerals.

Fluid flow paths 210 may be distributed circumferentially around the axis of rotation, in a rotationally symmetric manner. Opposing flow paths may balance each other and the system 200. For example, the flow path designated as 210a and the flow path designated as 210b are disposed on opposite sides of the axis of rotation, such that these flow paths would balance each other during rotation of the system 200.

Each of the flow paths 210 of the system of FIG. 200 may comprise a pressure developing portion, a pressure processing portion, and a pressure recovery portion analogous to elements 122, 124, and 126 of FIG. 1. Flow paths of various designs and shapes are within the scope of this embodiment.

As with the disclosure recited in connection with the system 100 of FIG. 1, the inlet 212 and outlet 214 of system 200 may be located at the same radial positions or different radial positions. Similarly, manifolds associated with the inlet 212 and/or outlet 214 may be located at the same or different radial positions. Still further, inlets and/or outlets corresponding to the separate fluid flow paths 210 may or may not be at the same radial positions as other inlets or outlets of individual fluid flow paths 210 of the system. Further, auxiliary outputs and inlets, such as elements 116 and 118 of FIG. 1, are within the scope of this embodiment.

Manifold systems within the scope of this disclosure, whether associated with the inlet 212 or outlet 214, may or may not distribute or collect working fluid uniformly between the flow paths 210 of the system 200. Further, the manifolds may passively distribute fluid, or comprise an active system, such as actively controlled valves or gates. A computer system may be configured to control an active manifold system. An active manifold system may further comprise sensors, such as mass, force or flow sensors, configured to provide input to a computer or other (e.g., analog) control system.

In some embodiments the system 200 may further comprise a circumferential restraint 240. For example, in an embodiment wherein the flow paths 210 of system 200 have the same profile and shape as the flow path 110 of system 100 (FIG. 1), a restraint disposed around the outer circumference of the system 200 may support and contain the system 200. The circumferential restraint 240 may, for example, reinforce the pressure processing portions (i.e., 124 of FIG. 1) by limiting radial deformation of these portions during operation. This may facilitate use of more flexible materials for the fluid flow paths 210, as radial deformation of the fluid flow paths 210 may be reinforced. Circular walls surrounding the fluid flow paths 210 as well as flexible tension members such as cables, belts, straps, cords, and wires are all within the scope of this disclosure.

In some embodiments, the system 200 may comprise a plurality of flow paths 210 disposed generally adjacent each other around the circumference of the system 200. In such embodiments the system 200 may resemble a disc or cylinder comprised of multiple flow paths 210. Flow paths 210 with varied cross-sections (such as narrower but taller near the center of the system, while wider but shorter near the circumference) may be designed to facilitate a constant flow through each fluid flow path 210 while disposing flow paths 210 directly adjacent each other. Such systems may or may not comprise circumferential restraints 240.

In some embodiments the system 200 may further comprise heat exchangers disposed between flow paths 210 or disposed between portions of a single flow path 210. Further, heating elements and or cooling elements (for example, resistance heaters or cooling fins) may be in thermal communication with portions of any flow path 210.

Some systems may also comprise a stirring mechanism in communication with the working fluid. Stirring mechanisms may be active or passive and may be disposed upstream of the system inlet 212 or may be disposed within the fluid flow paths 210. Such systems may be configured to reduce stratification of the working fluid, or may be configured as part of the pressure processing procedure of the system.

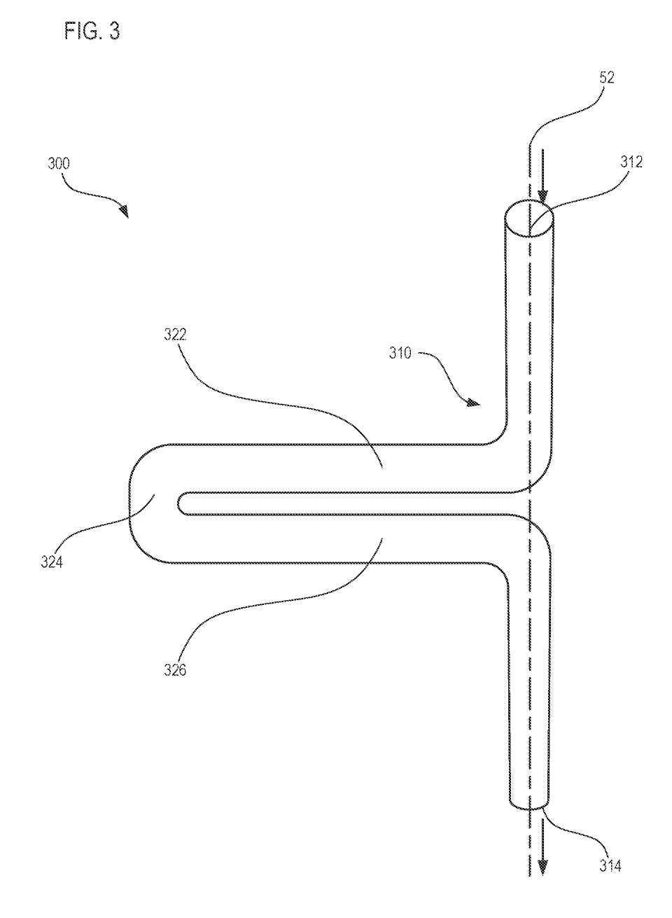

FIG. 3 is a schematic illustration of a side view of another embodiment of a flow path 310 of a pressure processing system 300. As noted above, it is within the scope of this disclosure to use the flow path 310 of the system 300 in connection with the system 200 of FIG. 2 and the disclosure recited in connection with FIGS. 1 and 2 may analogously be applied to the flow path 310 and system 300 of FIG. 3.

The system 300 of FIG. 3 comprises an inlet 312, an outlet 314, an axis of rotation 52, a pressure developing portion 322, a pressure processing portion 324, and a pressure recovery portion 326. As compared to the embodiment of FIG. 1, in the system 300 of FIG. 3, the pressure developing portion 322 and pressure recovery portions 326 are disposed adjacent each other.

The design of FIG. 3 may facilitate heat transfer between the pressure recovery portion 326 and the pressure developing portion 322 and vice versa. For example, in embodiments wherein the working fluid undergoes an exothermic reaction in the pressure processing portion 324, working fluid in the pressure recovery portion 326 may have more thermal energy per volume than working fluid in the pressure developing portion 322. The thermal energy could be dissipated by cooling fins or transferred out of the system via a heat exchanger or other heat transfer element, or, in some instances, a heat transfer element may be disposed in thermal communication with both the pressure recovery portion 326 and the pressure developing portion 322. The thermal energy could thus be used to preheat working fluid in the pressure developing portion 322. In some instances, contact between walls of the fluid flow path 210 may facilitate such heat transfer, and may or may not be supplemented with additional heat transfer elements.

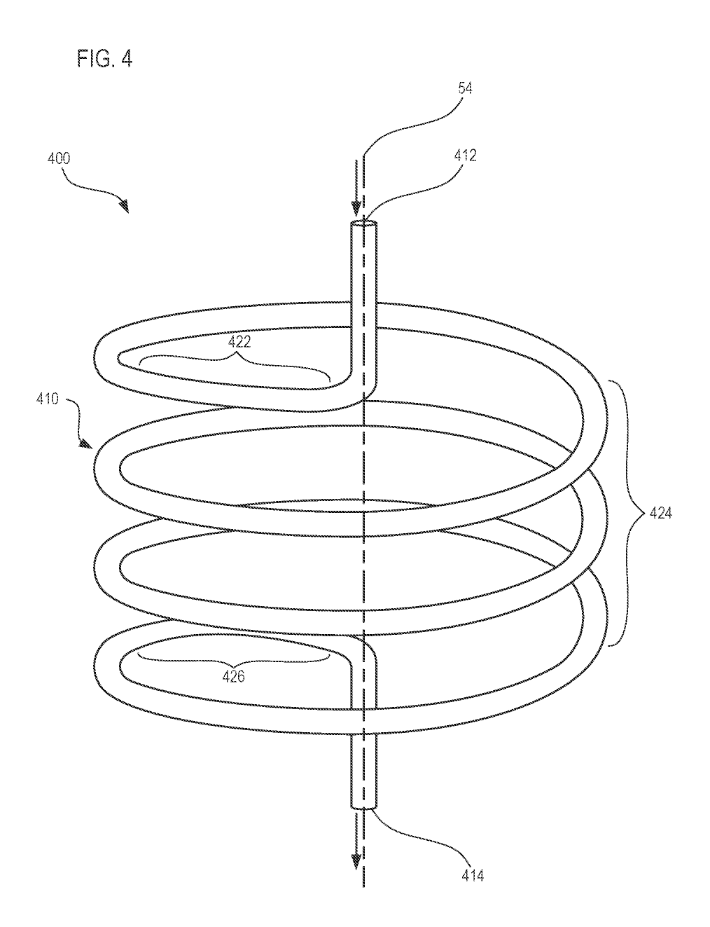

FIG. 4 is a schematic illustration of a side view of yet another embodiment of a flow path 410 of a pressure processing system 400. The system 400 of FIG. 4 comprises an inlet 412 and an outlet 414. Furthermore, an axis of rotation 54 is also indicated.

The embodiment of FIG. 4 illustrates a pressure processing system 400 with a helical fluid flow path 410. A pressure developing portion 422 extends from adjacent the inlet 412 to the circumference of the system 400. A pressure recovery portion 426 extends from the circumference of the system 400 to a point adjacent the outlet 414.

In the embodiment of FIG. 4 a pressure processing portion 424 comprises a helical portion running along the circumference of the system 400. In such an arrangement, the pressure processing portion 424 may be much longer than the pressure developing portion 422 and/or the pressure recovery portion 426.

The loops of the helical pressure processing portion 424 may be somewhat separated, as shown in FIG. 4, or may be disposed directly adjacent each other. The pitch, or number of loops per length along the axis of rotation, may also vary between embodiments. As with all the embodiments described above, use of circumferential restrains, manifolds, stirring mechanisms, heat exchangers, and other components are all within the scope of the embodiment of FIG. 4.

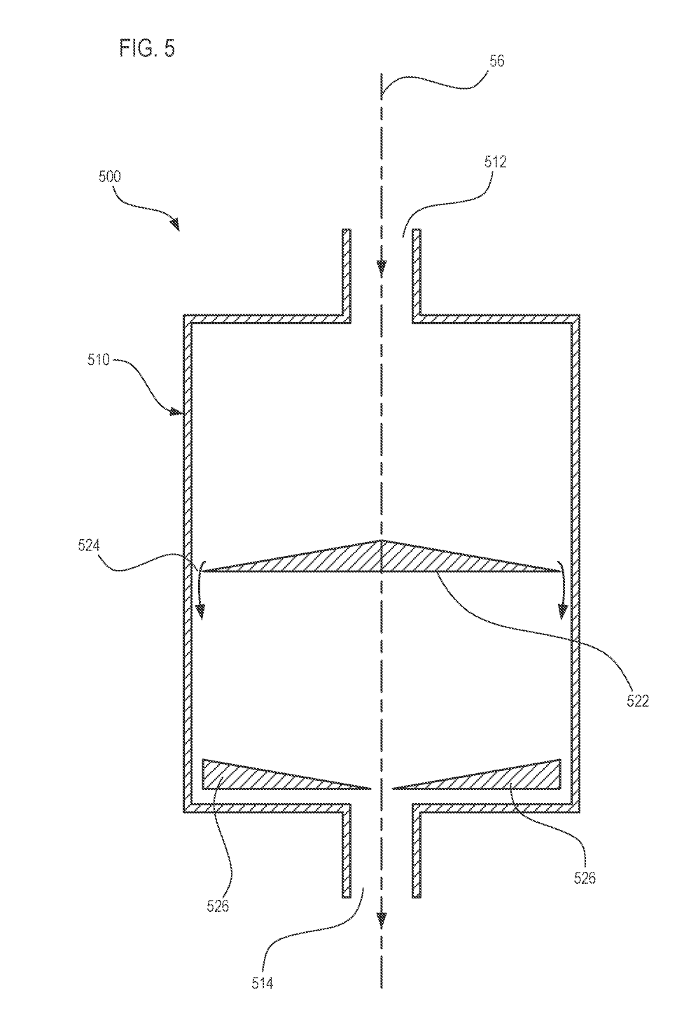

FIG. 5 is a schematic illustration of a cross-sectional view of another embodiment of a pressure processing system 500. As opposed to the other embodiments described above, the system 500 of FIG. 5 comprises a cylindrical processing chamber 510. Working fluid enters the system 500 through an inlet 512 and is recovered through an outlet 514. As with the other embodiments, rotation of the processing chamber 510 about an axis of rotation 56 may increase the pressure of the working fluid at the circumference of the processing chamber 510.

The system may further comprise a dividing disc, such as a pressure developing disc 522 configured to rotate with the processing chamber 510. The pressure developing disc 522 may or may not comprise vanes configured to facilitate transfer of angular momentum to the working fluid. Further, and as shown in the embodiment of FIG. 5, the pressure developing disc 522 may be sloped toward the circumference of the system 500. In an embodiment wherein the axis of rotation 56 is aligned with the direction of gravity, such a slope may further facilitate flow through the system 500.

Working fluid entering the system 500 through the inlet 512 may thus flow to the pressure developing disc 522 where it is accelerated and flows toward the circumference of the system 500. The working fluid may then flow past a pressure processing portion 524 between a rim of the pressure developing disc 522 and the wall of the processing chamber 510. This may be the highest pressure portion of the system 500.

From the pressure processing portion 524, the working fluid may flow to a pressure recovery disc 526 near the base of the processing chamber 510. In some embodiments, the pressure recovery disc 526 may be an integral portion of the base of the processing chamber 510. The pressure recovery disc 526 may have an outlet 514 at its center. Further, the pressure recovery disc 526 may comprise vanes to facilitate transfer of angular momentum from the working fluid back to the system 500. The pressure recovery disc 526 may also be sloped toward the outlet 514 to further promote working fluid flow through the system 500.

In some embodiments the outlet 514 opening may be larger than the inlet 512 opening to promote working fluid flow through the system 500. Auxiliary outlets, for example disposed in communication with the pressure processing portion 524, are also within the scope of this embodiment. Auxiliary inlets are also within the scope of this embodiment. Similarly, circumferential restraints, heat exchanges, stirring mechanisms, and so forth may be utilized with this embodiment.

In some embodiments, the pressure processing portion 524 may include components which substantially reduce the pressure of a portion of the fluid. For example, a reverse-osmosis filter membrane may pass a portion of the fluid, but with a large pressure drop. Such reduced-pressure fluid may flow out from the pressure processing portion via an auxiliary outlet. In some embodiments, fluid released via auxiliary outlets may be at low pressure, but may retain significant tangential velocity and kinetic energy. Part or all of this kinetic energy may be recovered by any suitable external mechanism. In some embodiments, such an energy recovery mechanism may take the form of an impulse turbine, such as a Pelton wheel, co-axial with the pressure processing system and configured to be driven by the fluid released via auxiliary outlets. In some embodiments, the recovered energy may be returned to the pressure processing system in the form of torque, via a mechanical drive or an electrical drive system (i.e., a generator and motor).

In some embodiments, both the pressure developing disc 522 and the pressure recovery disc 526 may comprise vanes, while in other embodiments, only one or neither of these elements may comprise vanes. In some instances the vanes may extend radially from the center of the disc, while in others they may be spirally oriented, including embodiments wherein vanes on the pressure recovery disc 526 spiral in an opposite direction from vanes on the pressure developing disc 522. Still further, systems having more than one pressure developing disc 522 and/or more than one pressure recovery disc 526 are within the scope of this disclosure.

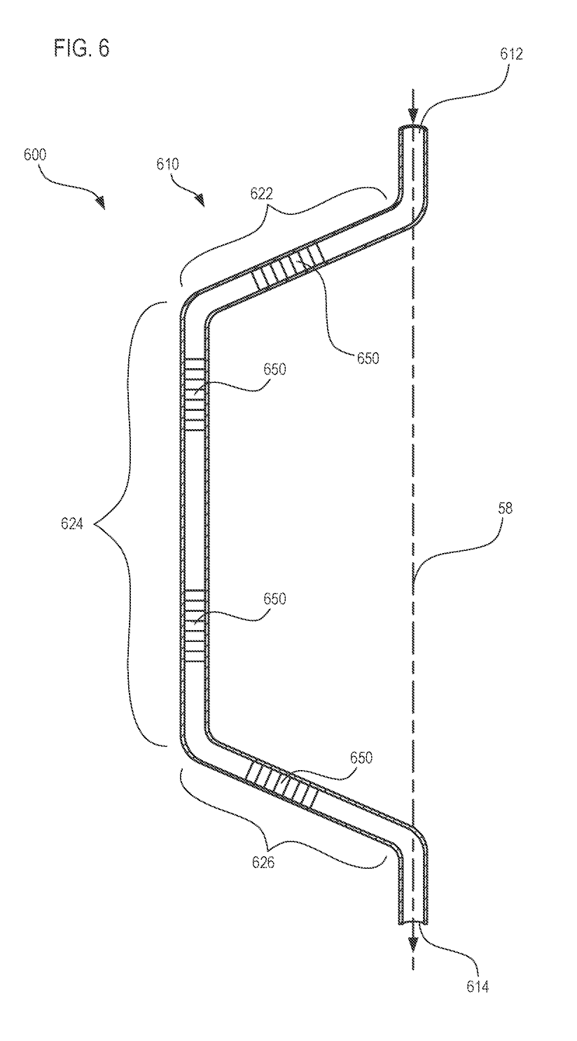

FIG. 6 is a schematic illustration of a cross-sectional view of another embodiment of a flow path 610 of a pressure processing system 600. The system 600 of FIG. 6 comprises an inlet 612, an outlet 614, a fluid flow path 610, and an axis of rotation 58. The fluid flow path 610 comprises a pressure developing portion 622, a pressure processing portion 624, and a pressure recovery portion 626.

Any of the disclosure recited in connection with the embodiment of FIG. 1, or disclosure that may be analogously applied to that embodiment, may also be applied to the embodiment of FIG. 6. The system 600 of FIG. 6 may be configured for function and use in an analogous manner to the system 100 of FIG. 1.

In addition to the elements recited in connection with the system 100 of FIG. 1, the system 600 of FIG. 6 further comprises pressure promoting members 650. The pressure promoting members 650 may comprise pistons, spheres, or other elements disposed within the fluid flow path 610. In some embodiments, the fluid flow paths 610 used in connection with pressure promoting members 650 may comprise constant cross-sections, while in other embodiments the pressure promoting members 650 may be configured for use in changing cross-section flow paths.

Fluid separating members, analogous to the pressure promoting members 650 are also within the scope of this disclosure. In some instances, fluid separating members may be disposed wtihin the flow paths in the same manner as the pressure promoting members 650, though the fluid separating members may or may not be configured to increase pressure along the flow path. Disclosure herein relating to separation of fluid segments, discussed in connection with pressure promoting members 650, may thus be analogously applied to fluid separating members.

The pressure promoting members 650 may be sized such that they can travel along the fluid flow path 610 while minimizing the degree to which working fluid can flow past the pressure promoting members 650. In some instances, the pressure promoting members 650 may seal against the inside of the fluid flow path 610, due to their size, material attributes, or auxiliary elements such as piston rings or o-rings.

The pressure promoting members 650 may be configured to decrease stratification of the working fluid, by dividing the working fluid into discrete segments.

The pressure promoting members 650 may be more or less dense than the working fluid. In embodiments wherein the pressure promoting members 650 are denser than the working fluid, the pressure promoting members 650 may function to increase pressure in the system 600 by exerting force on the working fluid as the system 600 rotates.

The system 600 may further comprise a pressure promoting member 650 drive mechanism configured to advance the pressure promoting members 650 along the fluid flow path 610. The pressure promoting member 650 drive mechanism may comprise a chain, cable, or other element coupled to the pressure promoting members 650. In some embodiments the pressure promoting member 650 drive mechanism may be configured to maintain a substantially constant quantity of working fluid between adjacent pressure promoting members 650.

Embodiments wherein the pressure promoting members 650 are driven by magnetic fields or field gradients, and wherein the pressure promoting members 650 comprise magnets, magnetizable (i.e. ferromagnetic) materials, or electrically conductive materials are within the scope of this disclosure. Embodiments where the pressure promoting members 650 comprise a magnetizable fluid or ferrofluid are also within the scope of this disclosure. Still further, magnetic drive mechanisms comprising a time-varying distribution of magnetic fields produced by sources external to the flow path, such that the time-varying fields apply axial (along the flow path) forces to the pressure promoting members are within the scope of this disclosure.

In some embodiments the pressure promoting members 650 may not be coupled to a pressure promoting member 650 drive mechanism. In some embodiments the pressure promoting members 650 may be collected at the outlet 614 and returned to the inlet 612 during use. For example, spherical pressure promoting members 650 could be recovered by straining working fluid at the outlet 614 and then returned to the inlet 612. Automated systems, including a conveyor configured to introduce pressure promoting members 650 into the inlet 612 in consistent intervals, are within the scope of this disclosure.

Various methods of using the systems described herein are within the scope of this disclosure, including methods of processing a working fluid while rotating a working fluid flow path to alter the pressure within the flow path. Filtration and various chemical processes are examples of processes within the scope of this disclosure.

Methods of recovering work energy through transfer of angular momentum from a working fluid are also within the scope of this disclosure. Similarly, methods of recovering and utilizing energy used to increase fluid pressure are within the scope of this disclosure.

In some embodiments, methods within the scope of this disclosure include inputting energy to bring a system to steady-state operation and methods of inputting energy to overcome losses in the system during steady-state operation. Working fluid may be pumped or gravity fed into the system. Further, the working fluid may be actively or passively distributed into the system and actively or passively stirred within the system.

In some embodiments, multiple working fluids may be introduced into a system. In some such embodiments multiple working fluids may be pressure processed together, including embodiments wherein the fluids enter the system at different radial positions or at different pressures.

Methods of bringing a system up to steady-state operation, including methods utilizing inert fluids during start-up, are within the scope of this disclosure.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art, having the benefit of this disclosure, that changes may be made to the details of the above-described embodiments without departing from the underlying principles of the disclosure herein.

1. A pressure processing system (PPS) comprising:
a first flow path extending between a first inlet and a first outlet, the first flow path comprising:
a pressure developing segment (PDS) in communication with the first inlet;
a pressure processing segment in communication with the pressure developing segment; and
a pressure recovery segment (PRS) in communication with the pressure processing segment and the first outlet; and
a plurality of flow separating members disposed within the first flow path;
wherein the first flow path is configured to rotate about an axis of rotation;
wherein the system is configured to transfer angular momentum to a working fluid while the working fluid is disposed in the pressure developing segment; and
wherein the system is configured to transfer angular momentum from the working fluid while the working fluid is disposed in the pressure recovery segment.

2. The PPS of claim 1, wherein the flow separating members comprise pressure promoting members, the pressure promoting members configured to increase working fluid pressure in the pressure processing segment.

3. (canceled)

4. The PPS of claim 1, wherein the flow separating members have a different density than the working fluid.

5. The PPS of claim 1, wherein the flow separating members affect fluid pressure via forces applied to the flow separating members.

6. The PPS of claim 5, wherein the forces are applied via a cable or other structure connecting the flow separating members together.

7. The PPS of claim 5, wherein the forces are applied via external magnetic fields or field gradients.

8-10. (canceled)

11. The PPS of claim 2, wherein the pressure promoting members increase the working fluid pressure along the PDS and wherein fluid pressure exerts a force on the pressure promoting members along the pressure recovery segment.

12. The PPS of claim 11, wherein energy transferred to the working fluid from the pressure promoting members along the PDS is substantially equal to the energy transferred from the working fluid to the pressure promoting members along the PRS when the system is in steady state operation.

13. (canceled)

14. The PPS of claim 1, wherein the angular momentum transferred to the working fluid is substantially equal to the angular momentum transferred from the working fluid when the system is in steady state operation.

15-20. (canceled)

21. The PPS of claim 2, wherein the pressure promoting members conform to the shape of the first flow path.

22. The PPS of claim 21, wherein the pressure promoting members substantially seal against a wall of the first flow path.

23. The PPS of claim 21, wherein the pressure promoting members comprise pistons coupled to sealing members configured to conform to a wall of the first flow path.

24-25. (canceled)

26. The PPS of claim 21, wherein the pressure promoting members comprise spheres.

27. (canceled)

28. The PPS of claim 2, wherein the pressure promoting members are denser than the working fluid.

29-39. (canceled)

40. The PPS of claim 2, wherein the first flow path comprises a substantially u-shaped flow path.

41-49. (canceled)

50. The PPS of claim 40, wherein the first inlet and the first outlet are disposed at the ends of the u-shape and the pressure processing segment is disposed at the bottom of the u-shape.

51-56. (canceled)

57. The PPS of claim 50, wherein the first inlet and the first outlet are disposed at the same radial distance from the axis of rotation.

58. The PPS of claim 50, wherein the first outlet is disposed radially outward from the first inlet with respect to the axis of rotation.

59-61. (canceled)

62. The PPS of claim 2, further comprising an auxiliary output adjacent the pressure processing segment.

63. The PPS of claim 62, wherein a portion of the working fluid leaves the system through the auxiliary output.

64-105. (canceled)

106. The PPS of claim 40, further comprising a second flow path extending between a second inlet and a second outlet, the second flow path comprising a pressure developing segment, a pressure processing segment, a pressure recovery segment, and a second plurality of pressure promoting members disposed within the second flow path, wherein the second flow path is configured to rotate about the axis of rotation.

107-109. (canceled)

110. The PPS of claim 106, further comprising a plurality of flow paths, wherein each flow path of the plurality of flow paths comprises a pressure developing segment, a pressure processing segment, and a pressure recovery segment, and wherein each flow path of the plurality of flow paths and the first and second flow paths are disposed symmetrically around the axis of rotation.

111-130. (canceled)

131. A PPS comprising:
a system inlet;
a system outlet;
a plurality of flow paths extending between the system inlet and the system outlet, each flow path of the plurality of flow paths comprising:
a PDS in communication with the system inlet;
a pressure processing segment in communication with the pressure developing segment; and
a PRS in communication with the pressure processing segment and the system outlet; and
a plurality of pressure promoting members disposed within the flow paths, the pressure promoting members configured to increase working fluid pressure within the pressure processing segments;
wherein each flow path of the plurality of flow paths is configured to rotate about an axis of rotation of the system;
wherein the flow paths of the plurality of flow paths are symmetrically arranged around the axis of rotation;
wherein the system is configured to transfer angular momentum to a working fluid while the working fluid is disposed in the pressure developing segments of the plurality of flow paths; and
wherein the system is configured to transfer angular momentum from the working fluid while the working fluid is disposed in the pressure recovery segments of the plurality of flow paths.

132. The PPS of claim 131, wherein each flow path comprises walls enclosing the flow path and interaction between the working fluid and the walls transfers angular momentum to and from the working fluid.

133. The PPS of claim 131, wherein the pressure promoting members are further configured to interact with the working fluid to recover energy used to rorate the system.

134. The PPS of claim 131, wherein the pressure promoting members are driven by an input force.

135. The PPS of claim 131, wherein the pressure promoting members increase the working fluid pressure along the pressure developing segments and wherein fluid pressure exerts a force on the pressure promoting members along the pressure recovery segments.

136-142. (canceled)

143. The PPS of claim 131, wherein the pressure promoting members conform to the shape of the flow paths.

144. The PPS of claim 143, wherein the pressure promoting members substantially seal against the walls of the flow paths.

145-149. (canceled)

150. The PPS of claim 131, further comprising a drive mechanism coupled to the plurality of pressure promoting members.

151. The PPS of claim 150, wherein the drive mechanism is configured to maintain a constant volume between adjacent pressure promoting members within the flow paths.

152. The PPS of claim 150, wherein the pressure promoting members are configured to separate the working fluid into discrete segments.

153. The PPS of claim 150, wherein the drive mechanism comprises a continuous chain coupled to the pressure promoting members.

154. The PPS of claim 150, wherein the drive mechanism comprises a magnetic drive configured such that the pressure promoting members are driven by a magnetic field.

155. The PPS of claim 150, wherein the pressure promoting members comprise a magnetizable fluid.

156-208. (canceled)

209. A method of pressure processing a working fluid, the method comprising:
introducing a first working fluid into a system inlet;
rotating the system such that centrifugal force tends to increase the first working fluid pressure within a portion of the system;
displacing a plurality of pressure promoting members along with the working fluid;
recovering a portion of the angular momentum transferred to the first working fluid before the first working fluid leaves the system; and
retrieving a portion of the first working fluid through a system outlet.

210. The method of claim 209, wherein the step of rotating the system comprises inputting rotational energy to overcome losses.

211. (canceled)

212. The method of claim 209, further comprising displacing the pressure promoting members within the system.

213. The method of claim 212, wherein the step of displacing the pressure promoting members comprises subjecting the pressure promoting members to a magnetic field.

214. (canceled)

215. The method of claim 209, further comprising separating the working fluid into discrete segments by displacing the pressure promoting members.

216-261. (canceled)
